(19) United States
(12) Patent Application Publication
(10) Pub. No.: US 2005/0103167 A1
(43) Pub. Date: May 19, 2005

(54) Adjustable wrench

(76) Inventors: Denis Lee Stewart, Payatai (NZ); Stephen Snedden, Waiuku (NZ)

Correspondence Address: O M Sam Zaghmout, Bio Intellectual Property Services, Lorton, VA, 22079, US

(21) Appl. No.: 10/485,821

(22) PCT Filed: Sep. 20, 2002
(86) PCT No.: PCT/NZ02/00185

(30) Foreign Application Priority Data
Oct. 15, 2001 (NZ) 513676

(51) Int. Cl. B25B 13/52

(52) U.S. Cl. 81/64

(57) ABSTRACT

An adjustable wrench as in FIG. 1 whereas the wrench 3 become a chain wrench and has a hole through the handle 5 for a chain shackle 4 and the Movable jaw member 2 has a pointed tooth 6 and radiused surfaces 7 on the inclined location. The jaw 2 tongue 8 has a recess 9 for a clock spring 10 its ends being fixed by holes 16 to both the movable jaw tongue 8 and the Handle 3 this spring 10 is preloaded so that the movable Jaw 2 forces towards the gripping surface on handle 3, the coiled portion of the spring being accommodated in the jaw tongue recess 9. The upper corner of movable Jaw 2 incorporates a pistol hammer shaped thumb grip 11. The handle edge 12 being a straight edge ruler with metric and imperial measurements 13 imbedded into the sides of the handle. On the handle ends, there is a radiused hexagonal shaped ring spanner 14 which is for imperial and metric bolts. The gripping surfaces 15 of the handle 3 and Jaw 2 grip surface 7 can be fitted with removable jaw covers called soft Jaws.

### CROSS-REFERENCES TO RELATED APPLICATION

This application is a 371 of PCT/NZ02/00185 filed Sep. 20, 2002, now WO 03/033214, the contents of which are incorporated herein by reference.

### TECHNICAL FIELD

This Invention relates to an adjustable wrench. For convenience only, the invention will predominantly be described as an adjustable wrench used for tightening and loosening nuts and pipes, or gripping or turning different objects and having multi function capabilities, however it should be understood that the wrench is not limited as such.

### BACKGROUND

Wrenches are well known, but many suffer from an undue restriction in terms of the size of objects that they can used with. This is often due to undue restrictions in the jaw openings, and having to change wrench sizes for larger objects.

It was noticed while developing the wrench of the present invention that a chain attachment could be added by putting a hole in the corner of the wrench handle end, this hole lets the wrench, with standard link chain and shackles, fit and turn larger objects than was previously possible.

Also conventional wrenches suffered from a poor jaw springing system, the spring being unduly exposed to the elements and a large part of the handle was needed to accommodate the springs, for example leaf springs or coil springs.

With an embodiment of the wrench of the present invention a clock spring is used such that it is confined to a minimal area in the wrench handle.

Also many conventional wrenches have no way of easily retracting or controlling the moving jaw so a suitable thumb grip was designed and added to some embodiments of the invention.

Also, with conventional wrenches jaw gripping areas are inclined to damage the work, so a new cam system grip has been designed for the jaw gripping area of an embodiment of the present invention.

Also, many conventional wrenches have plain handles, whereas in some embodiments of the present invention full advantage has been taken of the handle by adding a straight edge ruler with metric and imperial measurements embedded either side.

Also, it was noticed that common wrenches tend not to utilize the opposite end of the handle to the wrench end. Common wrenches usually have a hole for hanging the wrench, whereas in some embodiments of the invention we have used standard size ring spanners for convenience.

Conventional tools such as those mentioned above suffer from various disadvantages and limitations.

It is an object of some embodiments of the present invention to go at least some way towards addressing the forgoing problems, or to at least to provide the public with a useful choice.

Further aspects and advantages of the present invention will become apparent from the ensuing description which is given by way of example only.

The term “comprising” or similar as used herein is not intended to be limiting—for example it should not be taken to infer that there cannot be additional features or the like present.

### DISCLOSURE OF INVENTION

According to one aspect of the invention there is provided an adjustable wrench comprising, a handle means having a first grip surface and a recess portion formed therein adjacent to the said first grip surface, a movable jaw means having a second grip surface and a tongue portion adapted to be accommodated in the said recess portion, pivot means for pivotally connecting said movable jaw means and said handle means together, the said movable jaw means having a recess formed therein for accommodating a clock spring, a coil portion of the said spring being accommodated in the recess of the said movable jaw means throughout an allowable range of movement of the said movable jaw means so as to bias the said movable jaw means to pivot in a first sense which results in a reduction in distance between said first grip surface and said second grip surface, the handle means having connection means adjacent the first grip surface end of the handle means, the connection means adapted to receive a chain, cord, or strap and shackle attachment.

According to a further aspect of the present invention there is provided an adjustable wrench comprising, an elongated handle member being a straight edge ruler having a ring spanner at one end thereof, a first grip surface at an opposite end thereof, and a recess portion formed therein adjacent said first grip surface, a movable jaw member having a second grip surface, and a tongue member adapted to be accommodated in the said recess portion, pivot means for pivotally connecting said movable jaw member and said handle member together about a pivot axis passing through said handle member and said tongue member which has a recess to accommodate a clock spring within the said recess and fixed at opposite ends thereof to said movable member and said handle member respectively so as to bias the said movable member to pivot in a first sense which results in a reduction in the distance between the said first grip surface and said second grip surface and the coiled portion of the said clock spring is coiled around the pivot pin and being accommodated within the said tongue recess portion throughout an allowable movement of the said jaw member, this said spring recess in the jaw tongue has an un-recessed lip around the outside of it for stabilizing the jaw member and protecting the spring.

The said clock spring would be coiled and have ends that are bent in order to attach either end of the spring into place.

The end of the spring that hooks onto the handle member is bent just over 90 degrees in order to have a hooking effect in its hole.

According to another aspect of the present invention the said wrench handle recess is formed with a step on the inclined surface, this said step being to drill a hole in to hook the outer end of the spring into, this said hole being drilled right through for convenience and drainage and for easy removal of the spring.

According to another aspect of the present invention there is on the inner end of the spring a hole in the jaw tongue next to the pivot pin for the spring to attach, the spring end that hooks onto to the jaw tongue is bent at 90 degrees and gets hooked into a hole drilled near to the pin through the head tongue this hole being drilled right thru the tongue.

The spring is fitted with a pretension of 45-90 degrees inwards or as much as is necessary to get the right tension.

The clock spring wire diameter ranges in size from 8 mm-3 mm, the materials would be stainless steel or black spring steel with Nickel coating or similar, the clock spring's cross section would most likely be round but could be square or rectangular, and the spring layout would have as many coils as would be possible in the spring recess of the movable jaw tongue.

Two of these said clock springs can be added if extra tension is needed placed either side of the movable jaw tongue.

Another aspect of the present invention is that there is a hole through the wrench end of the handle allowing one to attach a standard chain and shackles.

This hole in the wrench handle is made to suit shackle pins, the 150 mm wrench and 200 mm wrench to suit a 6 mm shackle, the 250 mm and the 300 mm wrench to suit a 8 mm shackle, and the 300 mm to suit a 10 mm shackle. The shackles are used in conjunction with standard type chain that has a big enough link for the shackle ends to pass through when the chain is doubled in the mid section of the chain.

The said chain could also be replaced with a belt or wire rope strop which could be plastic coated or plastic coated chain, and might be used in conjunction with the appropriate soft jaws on the first and second grip surfaces.

The shackle on the floating end of the chain attachment usually would be a standard D shackle. This piece could also be a custom made item that could be removable or permanently mounted on the chain. It could be made in a shape such as a Belt Buckle or the foot holder on a saddle.

According to another aspect of the present invention the handle opposite end to the adjustable wrench head is formed as a curved hexagonal ring spanner which is made as the most common size ring spanner to fit the standard bolts on the market and to suit metric and imperial differences.

These said ring spanner sizes are for the 100 mm wrench ⅜ and 10 mm, for the 150 mm wrench ½ and 13 mm, for the 200 mm wrench ⅝ and 17 mm, for the 250 mm ¾ and 19 mm, for the 300 mm wrench 1′ and 24 mm, and for the 530 mm wrench 1″¼ and 30 mm.

These said ring spanners being formed with a width the same as the handle's body, and are formed like this to hold nuts and also to look like a conventional ring spanner. The wrench widths are designed to fit into the gap of a standard chain shackle—these are the approximate sizes, the 150 mm wrench is 10 mm wide and 200 mm wrench is 11 mm wide, the 250 mm wrench is 13 mm wide and the 300 mm wrench is 15 mm wide.

According to another aspect of the present invention the movable jaw member is formed as a beak shape with a point leading into a radius forming a cam grip portion which is in the form of a set of three protruding curved bumps.

According to another aspect of the present invention the first internal radius in the movable jaw cam grip area is made to fit and hook firmly onto chain shackle pins without damaging the shackles pin.

According to another aspect of the present invention there is on the top corner of the movable jaw member a thumb grip which is shaped like a thumb cock on a gun hammer, making it easier to control the movable jaw with one hand.

This thumb grip being formed from radiuses with a flat outer surface, the thumb grip goes on all size wrenches and can be made larger and decreased in size to suit the wrench appearance and improve usability.

The handle end and the movable jaw end has covers called soft jaws which are accessories.

The elongated handle first grip surface and the movable jaw the second grip surfaces can be shaped and recessed to accommodate the soft jaw covers so as to look as though the covers are the same size as the rest of the wrench body.

The surfaces of the soft jaws can be formed in any shape or texture with all sorts of gripping surfaces—rougher, smoother, softer, or harder.

The soft jaw materials could be Aluminum, or plastic, or Teflon, or rubber or some other material that could handle and is suited to be the gripping surfaces. They would be made of the most practical materials that would not damage the pipes and nuts but would still get maximum gripping and turning force.

According to another aspect of the present invention the handle could incorporate a folding knife—specifically the 150 mm model wrench, which could also incorporate other tools such as a screwdriver, a saw, pliers, etc.

According to another aspect of the present invention on larger model wrenches the handles may be formed as a Pogy bar or might be a jimmy lever or crow bar that would be shaped to pull nails out.

Further aspects of the present invention will become apparent from the ensuing description which is given by way of example only and with reference to the accompanying drawings.

### BRIEF DESCRIPTION OF DRAWINGS

A preferred embodiment of the invention will now be described with reference to the accompanying drawings in which,

FIG. 1: is an Adjustable Wrench with chain and shackles attached showing the whole wrench with the features and spring area exposed.

FIG. 2: is a picture of the wrench head and handle end clearly showing the shape of the thumb grip and chain hole and jaw gripping system.

FIG. 3: is a picture as in FIG. 1 where as the wrench has the chain and shackle attachment working on a large round object.

FIGS. 4 and 5: are pictures of the wrench end showing a different method of chain attachment.

FIG. 6: is the wrench chain system being used to dog steel into position.

FIG. 7: shows the wrench jaw and a cross section of the said jaw tongue showing the said spring recess and hole for attaching the spring to the head.

FIG. 8: is a clock spring with a side and end view in its free state.

FIG. 9: is the head with the clock spring fitting in its free state.

FIG. 10: shows a wrench end with a section BB through the handle showing the spring area with the spring in position assembled and in its pre-tensioned state.

FIGS. 11-18: show the wrench and the jaw cam gripping system when positioned on different sized hexagons and rounds.

FIG. 19: shows the soft jaws on the wrench handle and movable jaw member.

FIGS. 20 and 21: show the movable jaw soft jaws separate from the wrench in 3D with possible different types and showing the cut out for the chain shackle.

FIGS. 22-23: show the handle soft jaws shapes in 3D and possible different types.

FIG. 24: shows the wrench with the chain system and the soft jaws on together showing how the soft jaws are accommodated on the wrench when recessed.

FIG. 25: shows the 100 mm wrench design on the imperial side.

FIG. 26: shows the 100 mm wrench movable jaw and handle member separated on the metric side.

FIG. 27: depicts the 150 mm wrench showing the layout of the imperial side,

FIG. 28 shows the 150 mm wrench movable jaw and handle member separated and the metric side.

FIG. 29: is the 200 mm wrench showing the shape and layout of the design of the imperial side.

FIG. 30: is the 200 mm wrench showing the shape and layout of the wench movable jaw and handle member separated on the metric side.

FIG. 31: is the 250 mm wrench showing the shape and layout of the design in a assembled state imperial side.

FIG. 32: is the 250 mm wrench showing the shape and layout of the wrench movable jaw and handle separated the metric side.

FIGS. 33 and 34: show the layout and design of the 300 mm model wrench also with a spirit level incorporated in the handle member.

FIG. 35 depicts the 300 mm wrench handle member as a edge view showing the ring spanner width is the same as the wrench bodies width.

FIG. 36: shows the 530 mm wrench with a pogy handle and shows an edge view of the 530 mm wrench with a pogy bar for a handle.

FIG. 37: is a wrench handle that is a knife with a sheath on it.

FIGS. 38 and 39: depict the same knife as in FIG. 37 without the sheath, and the knife in the shape of a bowey knife and an edge view of the knife.

FIG. 40: shows a alternative knife handle shape that is in the shape of a dagger which has a sheath.

FIG. 41: shows the wrench as in FIG. 40 with the sheath on.

FIGS. 42 and 43: show a wrench handle that is slotted out having a folding locking pocket knife incorporated.

FIG. 44: depicts a handle for a wrench that is a torch.

FIG. 45: depicts a wrench handle that is a Jimmy lever that would be shaped to pull nails out.

FIG. 46: shows an edge view of the Jimmy lever.

FIGS. 47 and 48: show this type wrench where the handle is of a conventional shape and may have changeable heads.

FIGS. 49-51: show the wrench handle with a head in the shape of an axe or chopper.

FIG. 52: shows a wrench handle that has weldable attachments that would be used for fabricating.

FIG. 53: shows the previously mentioned attachments in use.

FIG. 54: shows another type of weld-on attachment.

FIGS. 55-56: show a chain system where the head has been replaced with a hook type link to hook onto the chain.

FIGS. 57-58: shows a wrench that has an alternatively shaped pogy for a handle that has holes and slots through it, and

FIG. 59-62: shows a wrench handle that is retractable and disassembles to breaks, down to small pieces for storage.

### DETAILED DESCRIPTION/BEST MODES FOR CARRYING OUT THE INVENTION

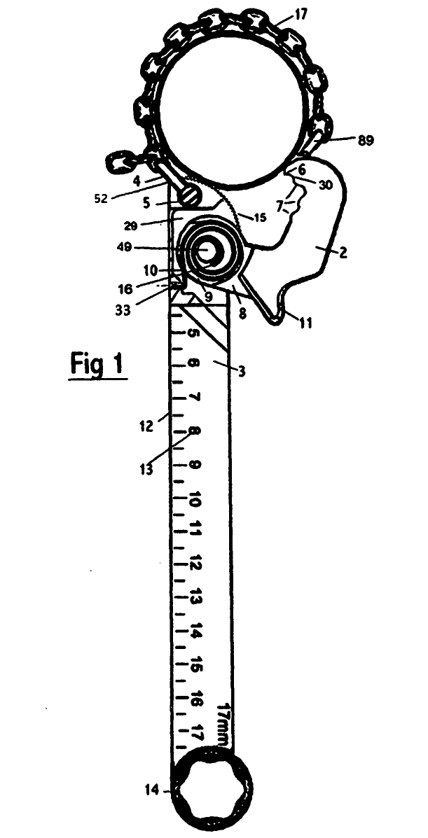

With reference to FIG. 1 there is shown a wrench according to an embodiment of the present invention.

This wrench comprises an elongate handle member generally indicated by 3 and a movable jaw member generally indicated by 2. The handle member 3 comprises a hexagonal ring spanner at one end thereof and a fixed jaw portion at the other end thereof. A slot 29 is formed in the end adjacent to the fixed jaw portion, for accommodating a tongue 8 of the movable jaw member 2.

A pivot hole 3 is drilled through the side faces of the slot 29 of the handle member 3 and through the tongue 8 of the movable jaw member 2 so that a pivot pin 49 may be fitted there through. The movable jaw member 2 is thus able to pivot relative to the handle member 3 about the pivot pin 49.

The pivot pin 49 comprises a knurl portion which may be pressed into a corresponding sized hole portion formed in one face of the slot 29, thereby providing a means for securing the pivot pin 49 in position.

The fixed jaw portion of the handle member 3 comprises a generally convex first grip surface 15 facing away from the location of the pivot pin 49, the first grip surface 15 is formed with serrations to assist in gripping an object. These Serrations are the minimum needed to grip steel pipe. These serrations can be finished at the bottom of the radius with a half a serration or these teeth could continue around the first grip surface 15 with a tight radius with teeth on as shown in 52 until the straight edge 12.

The movable jaw member 2 is generally formed as a beak shape with a second grip surface 7 formed at an end portion opposite to the tongue portion 8, formed on the surfaces inclined thereto.

As shown in FIG. 1 the second grip portion 7 has a radius 30 which is shaped to hold onto a shackle pin.

FIG. 2 shows the second grip portion 7 is also formed with a point 6 and a radiused cam grip portion 7 on the inner vertical surface which is in the form of three curved bumps in a double cam shape 7.

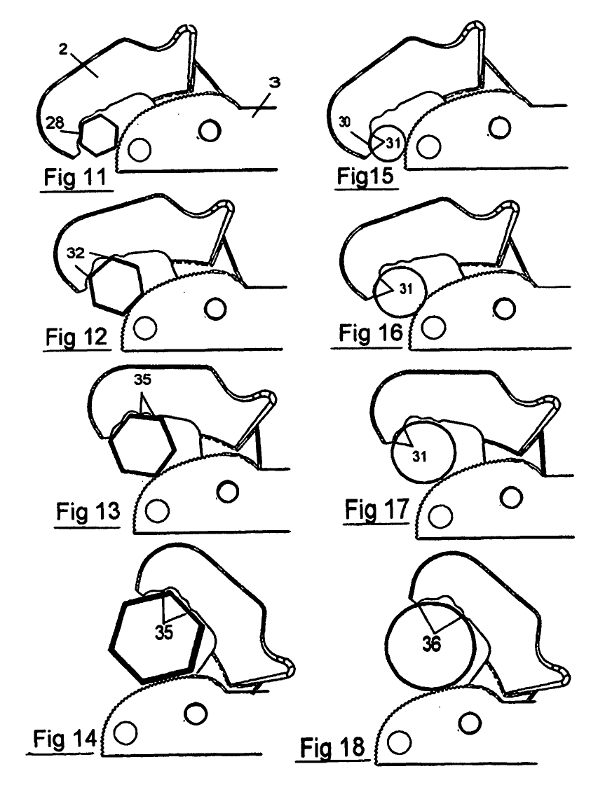

FIGS. 11 to 14 show how these bumps operate on a nut and FIGS. 15 to 18 show this radiused cam grip portion in operation on a round object of different sizes and how it may grip on three points.

As shown in FIG. 1, the handle member comprises a hole 5 being parallel to the first grip surface, the hole 5 is there to accommodate a shackle 4 and chain 17 attachment. The position of the said hole is close to the bottom corner of the handle member 3.

The chain shackle 4 that goes through the hole in the handle 5 is connected to standard chain of common size and materials, the chain 17 could be a type of belt or wire rope which could be plastic coated or plastic coated chain.

As shown in FIG. 24, a chain maybe plastic coated with the appropriate said soft jaws 38, 39 on the first and second grip surface 15 and 7.

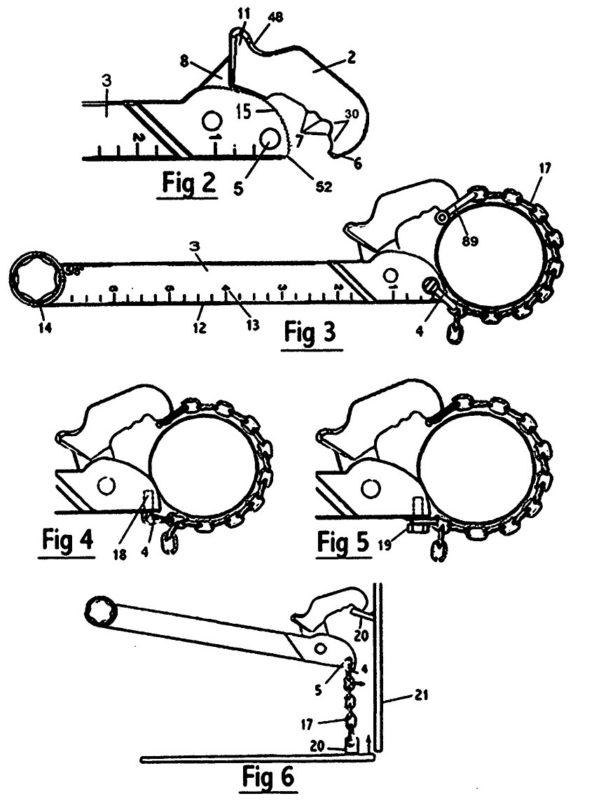

As shown in FIG. 3, the shackle 89 on the floating end of the chain attachment 17 usually would be a standard D shackle or a split shackle but could also be also a custom made piece that could be removable or permanently mounted on the chain. It could be made in a shape such as a belt buckle or foot holder on a saddle.

The wrench handle 3 widths may be made to fit into the gap of a standard chain shackle—these are the approximate sizes, the 150 mm wrench is 10 mm wide and 200 mm wrench is 11 mm wide, the 250 mm wrench is 13 mm wide and the 300 mm wrench is 15 mm wide. The holes 5 in the wrench handles 3 are made to suit the shackle pins, the 150 mm wrench to suit 6 mm shackles, the 200 mm wrench to suit an 8 mm shackle, and the 250 mm suits 8 mm, and the 300 mm wrench to suit a 10 mm, and the 530 mm to suit a 10 mm chain shackle.

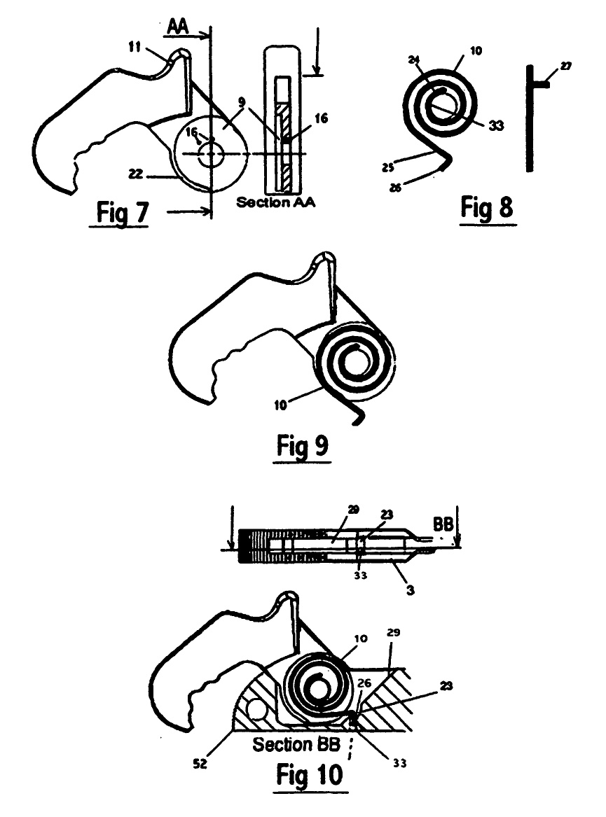

As shown in FIG. 7, the movable jaw tongue 8 has a recess 9 formed therein for accommodating the coiled portion of the clock spring 10 throughout the allowable range of movement of the said movable member, this recess 9 being deeper than the diameter of the spring 10, and this said recess 9 in the jaw tongue 8 has an un-recessed lip 22 around the outside of it.

As shown in FIG. 8 the spring wire would be coiled as in a clock spring and have the ends that are bent 26 in order to attach either end of the spring into place, both ends of the said clock spring 10 finish with a short piece of flat 24 and 25 before the wire bends 26 and 27.

As shown in FIG. 10, the clock spring 10 is fixed at both opposite ends thereof to the movable jaw member and said handle member.

The end of the spring 26 that hooks onto the handle member is bent just over 90 degrees in order to have a hooking effect in its hole.

Also as shown in FIG. 10 the wrench handle is formed with a step 23 on the inclined surface in the said recess 29 this said step being to drill a hole 33 to hook the outer end 26 of the clock spring into.

As shown in FIG. 10, section BB, shows the hole 33 being drilled on a angle right through for convenience and for easy spring removal.

As shown in FIG. 7 there is a hole 16 for the spring to attach to the jaw tongue next to the pivot pin.

As shown in FIG. 8 the spring end that hooks on to the head is bent at 90 degrees and is hooked onto a hole 16 which is slightly larger than the spring wire size and drilled near to the pin through the head tongue, this hole being drilled right through the tongue member as shown in section AA.

FIG. 9 shows one size clock spring in its free state, it would be coiled to have 2-4 coils, and on the inside of the spring at the start of the coiled section the spring radius 88 is made to suit and is governed by the pin size.

FIG. 10 shows a clock spring in its fitted state and has been fitted with a pretension of 45-90 degrees inwards or as much as is necessary to get the right tension.

The spring 10 wire diameter ranges in size from 8 mm-3 mm and the materials would be stainless steel or black spring steel with Nickel coating or similar.

The clock spring's cross section could be of square or rectangle or round materials, the spring layout would have as many coils as is possible in the spring recess 9 of the movable jaw tongue.

Two of these clock springs could be added if extra tension is needed, which can be placed either side of the head.

FIG. 7 shows the movable jaw member where the top corner has a thumb grip 11 which is shaped like a thumb cock on a gun hammer. This thumb grip 11 is formed from radiuses with a flat outer surface for easy forming, and the thumb grip 11 goes on various size wrenches and can be enlarged and decreased in size too suit the wrench's appearance and usability.

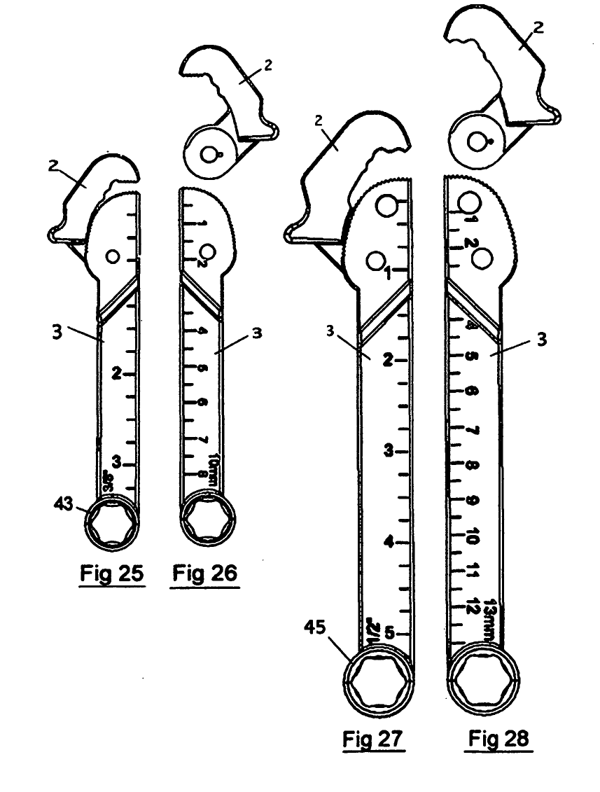

FIGS. 25, 27, 29, 31, 33, and 34 show the design and layout of wrenches showing how the said handle member 3 lengths are formed as straight edge rulers with metric and imperial measurements embedded either side.

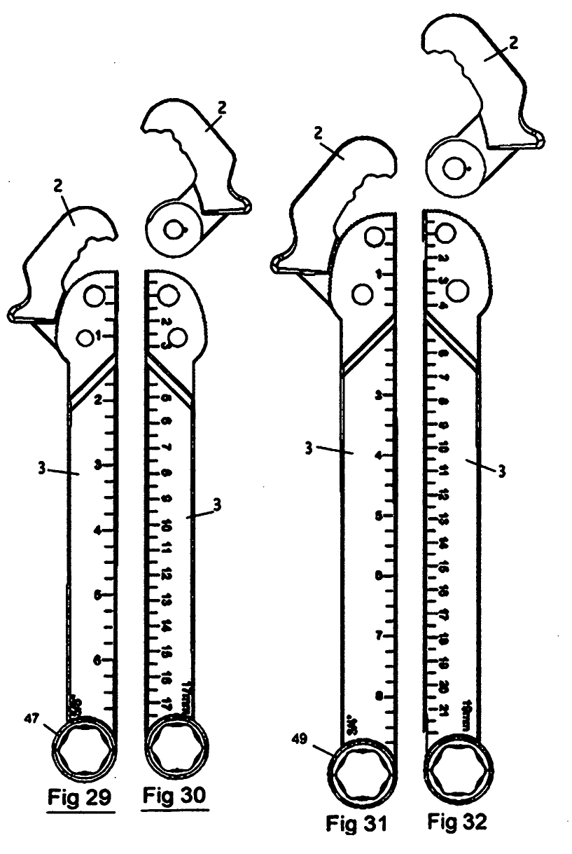

FIGS. 26, 28, 30, and 32 show the wrench handle 3 and movable jaw 2 in a separated state.

Also as shown in FIGS. 25 to 33 the handle's opposite ends to the adjustable wrench head have curved hexagonal ring spanners, these ring spanner sizes are ⅜ and 10 mm, ½ and 12 mm, ⅝ and 17 mm, ¾ and 19 mm, 1′ and 24 mm.

Also as shown in FIG. 35 the said ring spanners are formed with a width the same as the handle body 34 to look like a conventional ring spanner. As shown in FIG. 34 the ring spanners 14 are offset away from the straight edge.

FIGS. 47 and 48 show that the handles could be of conventional shape 68 or 69 and not having to be formed with a ruler or ring spanner.

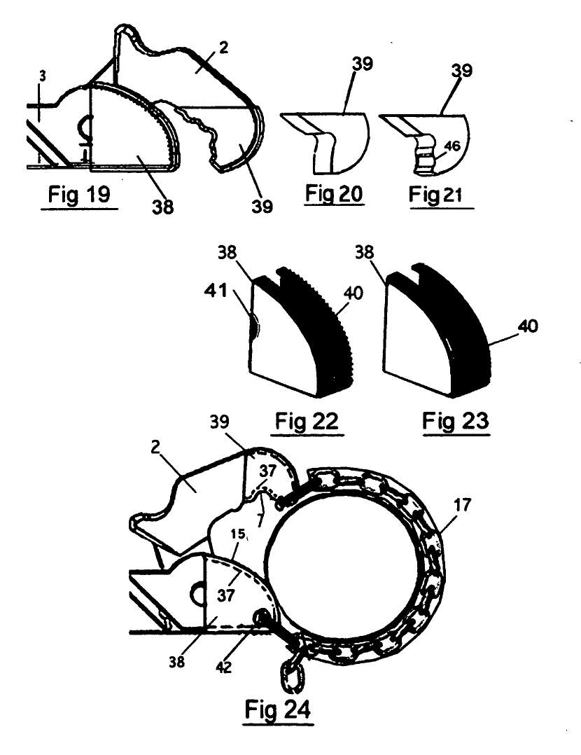

As shown in FIG. 19 the handle 3 end and the movable jaw 2 end area 7 may be covered by soft jaws 38 and 39 which are accessories that would be removable and replaceable.

As shown in FIG. 24 the elongated handle 3 first grip surface 15 and the movable jaw second grip 7 can be shaped and recessed like the hidden detail lines 37. These recess areas are all the way around the handle 3 end and the end of the movable jaw 2, and this recess would be to accommodate the soft jaw covers 38, 39 so as to look as though the covers are the same size as the rest of the wrench body.

As shown in FIGS. 20 and 21, the surfaces of the soft jaws 39 can be any shape or texture with all sorts of gripping surfaces smoother, softer, rougher or harder.

As shown in FIG. 21 the soft jaws for the movable head could have a cut-out 46 for getting a good solid grip on the chain shackle allowing the movable jaw and the chain shackle to touch steel to steel.

As shown in FIGS. 22 and 23 the gripping surface 40 of the handle soft jaws would be either flat or may have teeth and may be any suitable shape.

The soft jaws 39 materials could be aluminum or plastic or Teflon or rubber, any material that is rugged and could handle and suit the gripping surfaces. They would be made of the most practical materials that would not damage the pipes and nuts but would still get maximum gripping and turning force.

FIG. 22 reference 41 relates to a system for fastening the soft jaws on, these dimples would be built into the soft jaw to fastened it to the handle and jaw member allowing clip on while spring loaded, or the soft jaws could be pinned or screwed on.

The head soft jaw will be similarly fastened with a simple system clipped on or what ever method was best suited to attach the soft jaws 39.

As shown in FIGS. 47 to 50 the movable jaws 67 can be removable and changeable in the handle and the handles could be of common type 68, 69.

These changeable jaws can be made to specifically suit all sizes of pipe and nuts.

Another type of head could be a tomahawk axe or in the shape of a meat chopper 70.

As shown in FIGS. 37, 38 and 39 the wrench handle could be in the shape of a knife with a slide over sheath 55 to cover the knife blade 57 while the tool is being used as a wrench. The handle would have a clip attaching system 56 to hold the sheath on which is a simple push button or clip, which would double as a stop to stop the hand slipping towards the knife.

As shown in FIGS. 40 and 41 the wrench has another shape of knife 59 as a handle having a sheath 60 over the knife.

This handle and sheath could also have markings for measurements 60, and there would also be a similar catch arrangement for fastening the sheath in the most practical way.

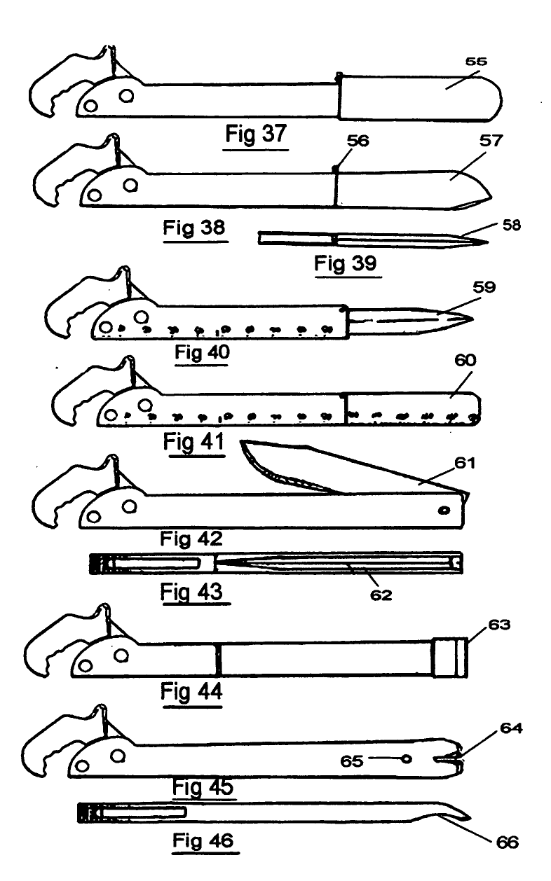

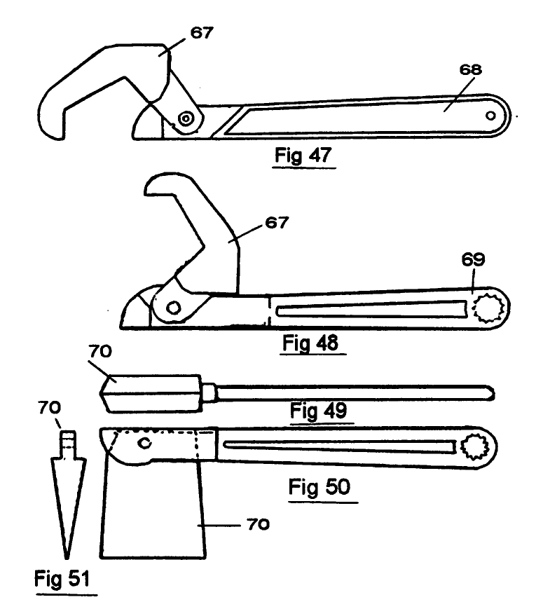

As shown in FIGS. 42 and 43 a handle incorporates a fold out knife specifically the 150 mm model wrench, which could also incorporate other tools that multi function like multi tools, such as screw drivers, saw, or pliers.

As shown in FIG. 44 a wrench handle 63 could be a torch and the head of the torch could be of such type that the beam adjusts and also the torch end surround can come off making it a miniature room light, the torch batteries being mounted in the tubular handle.

This handle 63 may also be an empty tube with a sealed end cap for using it as a dry storage compartment.

As shown in FIGS. 45 and 46 the wrench handle may have a jimmy lever or crow bar that would be shaped to pull nails out, which may have holes or slots 65 passing through its width.

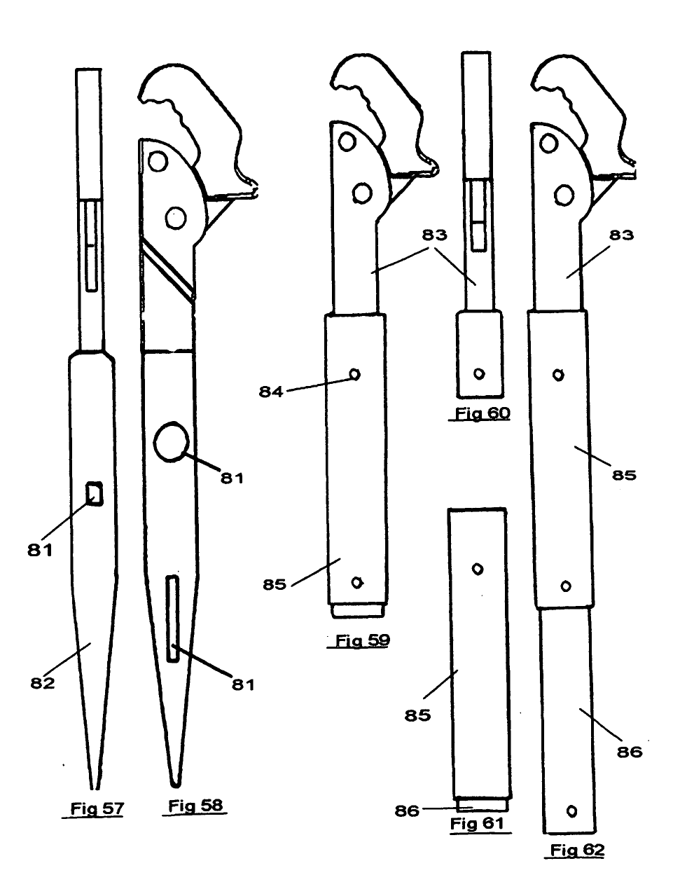

As shown in FIG. 36 and FIGS. 57 and 58 the handle member may be formed as a pogy bar which may have holes or slots 81 passing through its width.

As shown in FIG. 59 to 62 a large wrench may have a handle 85 that extends 86 to give greater leverage, yet collapses for compact storage, having a basic pin 84 or clip system for attaching the collapsible handle to the wrench and possibly a thread type handle lock.

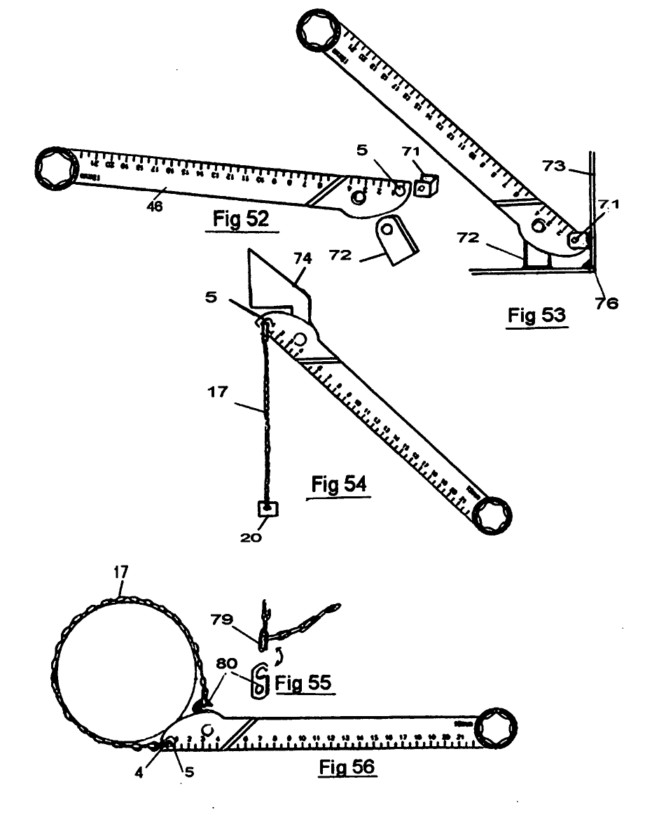

As shown in FIGS. 52 and 53 the wrench handle on its own could be used for dogging steel together 76, these weld on attachment pieces 71 and 72 could be made from all sorts of materials e.g., stainless for welding to stainless, aluminum for welding to aluminum and mild steel for welding to steel.

FIG. 54 shows the handle with different shaped wieldable attachments 74 and 20 which get welded to the two surfaces to be dogged into position for tacking to weld, this time utilizing a chain.

As shown in FIGS. 55 and 56 the handle with the hole 5 may be fitted with a custom made type link 80 that is shaped as a hook that can easily adjust the chain length so the handle alone can be used as a chain wrench.

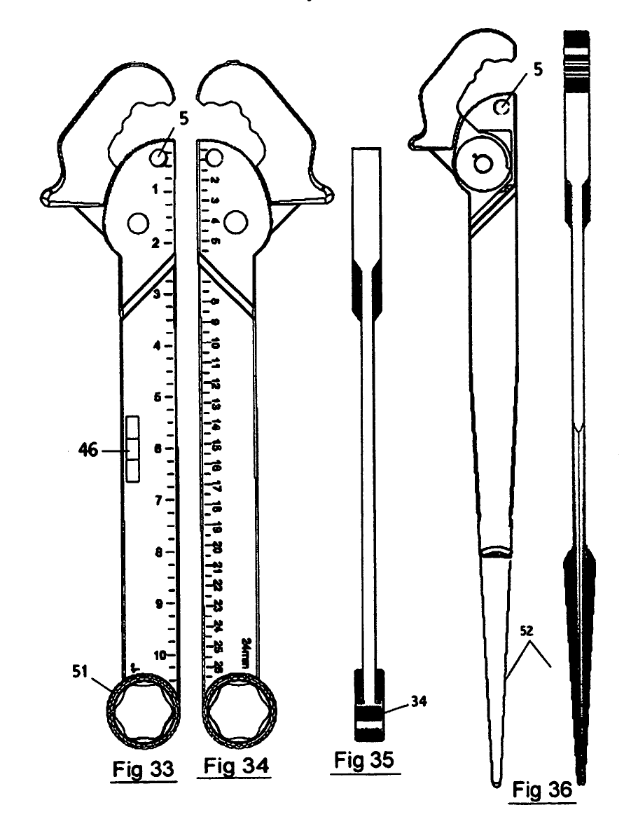

As shown in FIG. 33 the handle may be fitted with a spirit level 46.

It is believed the advantages of some embodiments of the invention are as follows, however it should be appreciated that all such advantages may not be realized on all embodiments of the invention, and the following list is therefore given by way of example, as being indicative of potential advantages of the present invention. Furthermore, it is not intended that the advantages of all embodiments of the present invention be restricted to those of the list which follows:

1. This wrench with the hole in the handle for a chain adaptation has turned this adjustable wrench into a very versatile chain wrench which may be easily used for tightening/loosening objects of various sizes.

2. The movable jaw gripping system may be formed as smooth radiused bumps that grip on to the flats of the bolts so that the corner of the nut is not damaged but the grip capability is maximized.

Since the wrench releases the grip with reverse rotation, an object is turned with successive clockwise, anti-clockwise movements of the wrench, with-out the need to disengage the wrench from the object being turned, with the said new bumps on the jaw when ratcheting the wrench on the object the jaw cams itself over the bolt and hangs on well making an easy to control ratcheting action and it will hold on strongly to the hexagon shape bolt or nuts and hold them in more positions for aligning and for getting different firm grips on the object for good operating in situations where accessibility is limited. Also with the new jaw gripping system pipes are gripped on two points one round cam point and one blunt pick firmly spreading the load reduce damage.

3. With this wrench clock spring we found it could be confined to a minimal area in the handle so the hand when working the wrench can get comfortably close to the work, the clock spring is also enclosed so that sparks from welding, grinding and gas cutting do not come into contact with the spring.

4. With the jaw a thumb grip was desired to take the wrench off the work in enclosed areas where the wrench can not be twisted to release the grip or for locating on delicate work and may be shaped so a child can function with ease.

5. The handle ends may be fitted with the most common size ring spanners to fit standard bolts on the market and to suit metric and imperial differences and operate in hard to reach areas where the wrench can not function, these ring spanners are offset upwards and are as wide as the wrench body and fit snugly into the palm of the hand allowing more leverage and the hand wont slip off the handle end.

6. With the handles optionally being rulers and straight edges these may be for advantage on the job having to carry less tools, for example when fabricating piping the straight edge can be used for lining up pipes or flanges when tack welding, the rulers are also useful for measuring bolt lengths and head sizes and will be useful for various other measurements and markings in general engineering or carpentry.

7. With the added feature of soft jaws it would allow one to turn objects without steel touching steel and give virtually no damage to the work.

Aspects of the present invention have been described by way of example only and it should be appreciated that modifications and additions may be made thereto without departing from the scope of the appended claims.

1-27. (canceled)

28. An adjustable wrench comprising, a handle means having a first grip surface and a recess portion formed therein adjacent to the said first grip surface, a movable jaw means having a second grip surface and a tongue portion adapted to be accommodated in the said recess portion, pivot means for pivotally connecting said movable jaw means and said handle means together, the said movable jaw means having a recess formed therein for accommodating a clock spring, a coil portion of the said spring being accommodated in the recess of the said movable jaw means throughout an allowable range of movement of the said movable jaw means so as to bias the said movable jaw means to pivot in a first sense which results in a reduction in distance between said first grip surface and said second grip surface, the handle means having connection means adjacent the first grip surface end of the handle means, the connection means adapted to receive at least one of a chain, cord, and strap and shackle attachment.

29. An adjustable wrench as in claim 28, wherein the connection means is a hole in the handle means,

30. An adjustable wrench as in claim 28, wherein the first grip surface finishes as a point which is half a serration.

31. An adjustable wrench as in claim 28, wherein the first grip surface finishes as a radius which extends to meet an edge of the handle.

32. An adjustable wrench as in claim 28, wherein the connection means is formed to the right size to suit a 6 mm and/or, 8 mm and/or 10 mm chain shackle pin.

33. An adjustable wrench as in claim 28, wherein the width of the wrench is made to fit into the gap of a standard size chain shackle.

34. An adjustable wrench as in claim 28, wherein the handle means is formed with a straight edge having at least one of metric and imperial ruler measurements.

35. An adjustable wrench as in claim 28, wherein the end of the handle means which is remote from the grip surfaces is in the form of a ring spanner which is for at least one of imperial and metric differences, this said ring spanner being offset from a straight edge of the handle means.

36. An adjustable wrench as in claim 28, wherein the recessed portion of the handle means is formed with a step for drilling a hole to hook an outer end of the clock spring, this hole being drilled right through the handle.

37. An adjustable wrench as in claim 28, wherein the said movable jaw means has on an inner inclined surface of the second grip surface a set of curved bumps substantially formed in a cam shape.

38. An adjustable wrench as in claim 28, wherein the said movable jaw means has a radiused portion suitable for receiving a chain shackle pin.

39. An adjustable wrench as in claim 28, wherein an outer part of the movable jaw means incorporates a thumb grip.

40. An adjustable wrench as in claim 28, wherein the clock spring is formed as a coil wound around a pivot pin.

41. An adjustable wrench as in claim 28, wherein the recess of the jaw means is in the tongue portion and is slightly bigger than the thickness of the spring.

42. An adjustable wrench as in claim 28, wherein there is a lip adjacent the outside of the recess in the jaw means which recess is in the tongue portion.

43. An adjustable wrench as in claim 28, wherein there is a hole in the tongue portion for the clock spring to attach to.

44. An adjustable wrench as in claim 28, wherein the clock spring has one end that is bent over approximately 90 degrees to the rest of the spring, this being on an end of the spring that connects to the handle means, and the other end of the spring is also bent over approximately 90 degrees.

45. An adjustable wrench as in claim 28, wherein the said clock spring, adjacent each end part of a coil portion thereof, has a short piece of flat before 90 degree bends at each end.

46. An adjustable wrench as in claim 28, wherein the said clock spring is fitted pretensioned inwards by approximately 45 to approximately 90 degrees.

47. An adjustable wrench as in claim 28, having covers for the first and second grip surfaces.

48. An adjustable wrench as in claim 28, wherein the said handle means comprises at least one of a tapered portion, a lever portion, a folding knife, a spirit level, and a weldable attachment.

49. An adjustable wrench as in claim 28, wherein the said handle means meets the jaw means at an angle of substantially 45 degrees.

50. An adjustable wrench as in claim 28 incorporating at least one of a chain, cord and strap arrangement fitted to the connection means.

51. An adjustable wrench comprising, a handle means having a first grip surface and a recess portion formed therein adjacent to the said first grip surface, a movable jaw means having a second grip surface and a tongue portion adapted to be accommodated in the said recess portion, pivot means for pivotally connecting said movable jaw means and said handle means together, the said movable jaw means having a recess formed therein for accommodating a clock spring, a coil portion of the said spring being accommodated in the recess of the said movable jaw means throughout an allowable range of movement of the said movable jaw means so as to bias the said movable jaw means to pivot in a first sense which results in a reduction in distance between said first grip surface and said second grip surface, the handle means having an aperture adjacent the first grip surface end of the handle means, the aperture adapted to receive at least one of a chain, cord, and strap and shackle attachment.
